(19) United States
(12) Patent Application Publication
(10) Pub. No.: US 2007/0284523 A1
(43) Pub. Date: Dec. 13, 2007

(54) Process and apparatus for 15-nitrogen isotope determination of condensed phase samples

(75) Inventors: Michael May, Dayton, OH (US); Michael Gray, Dayton, OH (US)

Correspondence Address: SENNIGER POWERS (SGM), ONE METROPOLITAN SQUARE, 16TH FLOOR, ST. LOUIS, MO, 63102, US

(73) Assignee: Sigma-Aldrich Co., St. Louis, MO (US)

(21) Appl. No.: 11/423,317

(22) Filed: Jun. 9, 2006

(51) Int. Cl. B01D 59/44

(52) U.S. Cl. 250/288

(57) ABSTRACT

A novel apparatus and process for isolating a nitrogen fraction representative of the nitrogen contained in a specimen of a condensed phase nitrogenous organic composition. In the process the nitrogen fraction is isolated in the form of a dinitrogen gas that may be introduced into a mass spectrometer for determining the proportion of the nitrogen isotope content of the composition that is constituted by ¹⁵N.

### FIELD OF THE INVENTION

This invention relates to the field of isotope analysis, and more particularly to a useful process and apparatus for determining the ¹⁵N content of a condensed phase nitrogenous composition.

As described by Metges and Petzke, “The Use of GC-C-IRMS for the Analysis of Stable Isotope Enrichment in Nitrogenous Compounds,” Chapter 7, Methods of Amino Acid and Protein Metabolism, A. E. El-Khoury, Ed., CRC Press, Boca Raton (1999), the relative natural abundance of the main stable isotopes in bioelements (²H, ¹³C, ¹⁵N, ¹⁸O) varies within subtle limits due to isotope fractionation processes in nature. Isotope labeling is also widely used in various industrial applications for tracing flow paths, determining flow volumes and evaluating chemical and biological reactions. In biological and medical research applications, isotope labeling is used for evaluating the distribution and metabolic or pharmacokinetic fate of nutrients, pharmaceuticals, etc.

Various methods are known for determining the ¹³C and/or ¹⁵N content of organic compounds, including proteins. Typically, proteins are subjected to wet digestion, e.g., in hydrochloric acid, by which they are degraded into mixtures of their constituent amino acids, after which the amino acids are derivatized and subjected to analysis. Prior to isotope analysis, the amino acid derivatives may be separated by gas chromatography. The individual amino acid derivatives are then successively subjected to vapor phase combustion in a dynamic flow process wherein the combustion gas product is treated to isolate a CO₂ fraction, which is introduced into a mass spectrometer for ¹³C analysis, and/or an N₂ fraction, which is introduced into a mass spectrometer for ¹⁵N analysis. In some systems, the combustion product gas is subjected to gas chromatography to separate the desired analyte, e.g., CO₂ or N₂, from other gases prior to introduction of the analyte gas into the mass spectrometer. These dynamic systems often use specialized isotope ratio mass spectrometers for determination of isotope content. Other relatively volatile organic compounds can also be separated by GC and subjected to isotopic analysis in the same manner as the amino acids obtained from digestion of proteins.

In other methods, amino acids obtained by protein digestion, or other nitrogenous organic compounds have been analyzed for isotopic content using nuclear magnetic resonance (NMR). For many applications, especially intractable biosynthesized proteins and peptides, NMR has not provided satisfactory results. This is related to issues such as hydrogen exchange, NMR spectral complexity, and ¹⁵N-signal sensitivity.

Metges and Petzke, supra describe a system employing isotope ratio mass spectrometry for determining ¹³C, ¹⁵N and/or ¹⁸O content of a composition such as a mixture of amino acids. Where the composition of interest is a protein or peptide, it would typically be subjected to wet acid digestion to provide the amino acid components used in the analysis. In the reference system, each of the amino acids may be separately analyzed with respect to C or N isotope content by conversion to a gas comprising CO₂ or N₂, isolation of the gas whose isotopic composition is to be determined, and analysis of the isolated gas stream using an isotope ratio mass spectrometer. Preparatory to combustion, the amino acid derivatives are separated in a capillary column and each derivative of interest is then oxidized in the gas phase in an oxidation oven which comprises an alumina tube filled with various combinations of nichrome or copper oxide, nickel oxide and platinum wires. A mixture comprising CO₂, H₂O, N₂ and NOₓ flows from the combustion oven to a reduction oven where the gas is contacted with elemental copper for reduction of NOₓ and scavenging of surplus oxygen. Water vapor is removed by passing the gas through a water-permeable membrane or cold trap. Where the object is to analyze the nitrogen content of the sample, the gas may be passed through a trap maintained near −196° C. for removal of CO₂. From the exit of the capillary column to inlet of the mass spectrometer, the gas phase passes through the system substantially in plug flow. Metal oxide oxidants can be periodically replenished by introduction of molecular oxygen into the oxidation oven.

Matthews and Hayes, “Isotope-Ratio-Monitoring Gas Chromatography-Mass Spectrometry,” Analytical Chemistry, Vol. 50, No. 11, pp. 1485 to 1473 (September 1978) also describe a system wherein a sample is separated by gas chromatography and quantitatively oxidized in the gas phase in a catalytic furnace. As described in FIG. 2 thereof, the combustion oven is serially connected to water and carbon dioxide traps and the traps are connected to the GCMS separator. CuO is used as oxidant, supplemented by O₂. A pyrex tube downstream of the furnace is filled with magnesium perchlorate to trap H₂O. A liquid N₂ cooled trap downstream of the magnesium perchlorate water trap serves to remove CO₂ before the gas phase enters the mass spectrometer. Nitrogen isotope analysis is specifically described.

Preston and Owens, “Interfacing an Automatic Elemental Analyzer with an Isotope Ratio Mass Spectrometer; the Potential for Fully Automated Total Nitrogen and Nitrogen-15 Analysis,” Analyst, August 1983, Vol. 108, pp. 971-977 describe a system wherein combustion of a specimen to be analyzed is conducted per the Dumas method in an automatic nitrogen analyzer comprising an elemental gas chromatograph. Combustion gases are separated by gas chromatography and flow serially to a mass spectrometer.

Other systems for isotope ratio analysis are described in Hall U.S. Pat. No. 4,866,270, Brand U.S. Pat. No. 5,424,539, and Ellis et al. U.S. Pat. No. 5,783,741.

Gustin et al, “A Simple, Rapid Automatic Micro-Dumas Apparatus for Nitrogen Determination,” Microchemical J., Vol. IV, pp. 43-54 (1960) describes an apparatus (FIG. 2 of the reference) for Dumas combustion comprising a first unit, consisting of a temporary packing of CuO wherein organic compounds are pyrolyzed quickly at 850° C., and a second unit consisting of Cu—CuO at 400° C. to 500° C., in the presence of which CO₂ does not dissociate and any CO present may be oxidized to CO₂. CO₂ is absorbed in caustic solution. Samples are introduced into the reaction tube in Pt or alumina disposable boats.

A need remains for a process and apparatus that are useful and effective for the determination of the ¹⁵N content of solid phase samples, e.g., relatively intractable biosynthesized solids such as proteins and peptides or chemically synthesized solids of relatively low vapor pressure such as nitroanilines and amino acids. Such solid specimens can contain significant quantities of bound solvent. For purposes of effective and accurate analysis, it may be necessary or desirable to remove the bound solvents, especially where they are nitrogenous reagents such as acetonitrile, pyridine, or ammonium hydroxide in which the ¹⁵N/¹⁴N ratio may differ significantly from the ¹⁵N/¹⁴N ratio in the sample.

Determination of ¹⁵N vs. ¹⁴N by mass spectrometry is complicated by the fact that CO has the same nominal mass as ¹⁴N₂, i.e., a molecular weight of 28, and ¹³CO has a molecular weight 29. By comparison, dinitrogen species relatively enriched in ¹⁵N have molecular weights of 30 (¹⁵N₂) or 29 (¹⁵N¹⁴N). Thus, it is desirable to eliminate CO from an N₂ sample before it is introduced into the spectrometer.

### SUMMARY OF THE INVENTION

Among the several objects of certain or various preferred embodiments of the present invention may be noted the provision of a process for the determination of the proportion of the nitrogen isotope content of a composition that is constituted by ¹⁵N; the provision of a process which may be practiced to determine such proportion of ¹⁵N in a condensed phase sample; the provision of a process to determine such proportion of ¹⁵N in a solid phase sample; the provision of such a process in which bound solvent may be removed from a solid specimen before ¹⁵N analysis thereof; the provision of such a process which may be practiced remotely from a mass spectrometer to produce a nitrogen gas combustion product that can be delivered to the mass spectrometer; the provision of such a process which can be conducted without the need for chromatographic separation of gaseous combustion products; the provision of such a process by which the ¹⁵N content of a peptide, protein, a cell culture or other cellular specimen, e.g., algal cells, or a tissue specimen can be determined without the necessity of, and preferably without, wet digestion or chromatographic separation of constituent amino acids; the provision of such a process which may be conducted on a batch basis; the provision of such a process which can be conducted in a free-convectively mixed process chamber; and the provision of apparatus useful in conducting the process.

The present invention provides a process and apparatus that are conveniently and advantageously used to determine the proportion of the nitrogen content of a composition that is constituted by ¹⁵N. The process and apparatus are advantageously adapted for the determination of the ¹⁵N content of a condensed phase composition, especially a composition that is in the solid state under ambient conditions.

In a preferred embodiment, therefore, the present invention is directed to a process for isolating a nitrogen fraction representative of the nitrogen contained in a specimen of a condensed phase nitrogenous organic composition. The representative fraction is isolated in the form of a dinitrogen gas that may be introduced into a mass spectrometer for determining the proportion of the nitrogen isotope content of the composition that is constituted by ¹⁵N. In accordance with the process, a specimen comprising the condensed phase composition or a vapor generated from the condensed phase composition is contacted with a primary oxidant in a combustion region within a zone for generation and isolation of N₂ derived from nitrogen contained in the specimen. The specimen is reacted in the combustion region to generate a combustion product gas comprising N₂, CO₂ and water. In a sorption region spaced from said combustion region within the generation and isolation zone, combustion gas is contacted with a sorbent effective for sorption of a gas component selected from the group consisting of CO₂, water and combinations thereof. The gas component is sorbed from the gas phase to the sorbent in the sorption region, thereby providing a nitrogen gas fraction of which the sum of the water vapor content and the CO₂ content comprises not more than about 5 volume %, basis N₂.

The invention is further directed to a process for isolating a nitrogen fraction as defined above wherein the condensed phase specimen is contacted with a primary oxidant in a combustion region within a zone for generation and isolation of N₂ derived from nitrogen contained in the specimen, the gas phase being subject to convective mixing within the zone. The composition is reacted in the combustion region to generate a combustion product gas comprising N₂, CO₂ and water. In a sorption region within the generation and isolation zone, the combustion gas is contacted with a sorbent effective for sorption of a gas component of the combustion gas selected from the group consisting of CO₂, water and combinations thereof. The gas component is sorbed from the gas phase to the sorbent in the sorption region, thereby providing a nitrogen gas fraction of which the sum of the water vapor content and the CO₂ content comprises not more than about 5 volume %, basis N₂.

The invention is further directed to a process for isolating a nitrogen fraction as defined above wherein the specimen is contacting with a primary oxidant in a combustion region within a zone for generation and isolation of N₂ derived from nitrogen contained in the specimen, and the composition is reacted in the combustion region to generate a combustion product gas comprising N₂, CO₂ and water. In a sorption region within the generation and isolation zone, the combustion gas is contacted with a sorbent effective for sorption of a gas component selected from the group consisting of CO₂, water and combinations thereof, and the gas component is sorbed from the gas phase to the sorbent in the sorption region. The gas phase throughout the generation and isolation zone is caused to become substantially uniformly mixed, thereby providing a nitrogen gas fraction of which the sum of the water content and the CO₂ content comprises not more than about 5 volume %, basis N₂.

The invention is further directed to an apparatus for isolating a nitrogen fraction representative of the nitrogen contained in a specimen of a nitrogenous organic composition, the fraction being isolated in the form of a dinitrogen gas that may be introduced into a mass spectrometer for determining the proportion of the nitrogen isotope content of said composition that is constituted by ¹⁵N. The apparatus comprises a tubular process vessel having a primary gas port for influx of a primary oxidant gas and/or efflux of nitrogen gas generated by combustion within the vessel, and a first station within the vessel for receiving a condensed phase specimen of a nitrogenous organic composition. The first station is spaced from the primary port of the process vessel with respect to the longitudinal axis of the vessel. The apparatus further comprises a second station within the vessel. The second station is spaced from both the first station and the process vessel primary port with respect to the longitudinal axis of the vessel. The second station is adapted to receive a sorbent, the sorbent being effective for sorption of a component of a gas phase in contact with the sorbent, the sorbent being effective for sorption of a gas component selected from the group consisting of water, carbon dioxide and combinations thereof. The apparatus further comprises a furnace for heating the organic composition in the presence of a primary oxidant to effect combustion of the specimen and generation of a combustion product gas comprising N₂, CO₂ and water. Preferably, the tubular process vessel is spatially arranged with the furnace to establish an axial thermal gradient along the longitudinal axis of the vessel during combustion.

The invention is further directed to a process for isolating a nitrogen fraction as specified above wherein a specimen comprising the condensed phase composition or a vapor generated from the condensed phase composition is contacted with a primary oxidant in a convectively mixed combustion region within a zone for generation and isolation of N₂ derived from nitrogen contained in the specimen. The specimen is reacted in the combustion region to generate a combustion product gas comprising N₂, CO₂ and water. In a sorption region spaced from the combustion region within the generation and isolation zone, the combustion gas is contacted with a sorbent effective for sorption of a gas component selected from the group consisting of CO₂, water and combinations thereof. The gas component is sorbed from the gas phase to the sorbent in the sorption region, thereby providing a nitrogen gas fraction of which the sum of the water vapor content and the CO₂ content comprises is not more than about 5 volume %, basis N₂.

Other objects and features will be in part apparent and in part pointed out hereinafter.

### BRIEF DESCRIPTION OF THE DRAWINGS

FIG. 1 is a schematic block diagram illustrating a preferred embodiment of the process of the invention;

FIG. 2 is an exploded view in section of an apparatus comprising a process vessel plus auxiliaries useful in carrying out the process of the invention, which includes both a combustion station for a nitrogenous organic compound and, spaced from the combustion station, a sorption station for sorption of CO₂ and water vapor generated in the combustion;

FIG. 3 is a schematic illustration of an apparatus similar to that of FIG. 2 but containing a third station for reduction of NOₓ, the third station being spaced from both the combustion station and the sorption station within the process vessel; shown at one end of the apparatus is an exploded view of a specimen containmnet module for introducing a condensed phase nitrogenous sample into the process vessel;

FIG. 4 is an exploded perspective view in section of an assembly comprising a gas manifold for use in connection with the process vessel of FIG. 2 or 3 in carrying out the process of the invention;

FIG. 5 is a typical longitudinal (axial) temperature profile in the tubular process vessel of FIG. 1 during combustion of a sample to generate a combustion product gas substantially comprising N₂; and

FIG. 6 is an exploded plan view in section of a specimen containment module which is adapted for attachment to the tubular process vessel as illustrated in either FIG. 2 or FIG. 3.

Corresponding reference characters indicate corresponding parts throughout the drawings.

### DETAILED DESCRIPTION OF THE INVENTION

In accordance with the present invention, an advantageous process and apparatus are provided by which a specimen of a nitrogenous composition may be reacted to generate gases suitable for mass spectrometric determination of the proportion of the composition nitrogen content that is constituted by ¹⁵N. Preferably a specimen of the composition is reacted using dry combustion, i.e., without need for preliminary acid digestion of a composition such as a biosynthesized protein or peptide to break it down into its constituent amino acids. By directly combusting a specimen of an unknown composition, any contamination or adulteration that might otherwise arise in the digestion process may be avoided. Direct combustion also avoids the corrosive conditions typically incurred in wet digestion with hydrochloric acid. The process is relatively practical and straightforward, and the apparatus simple, economical and robust. Moreover, the system is amenable to the determination of ¹⁵N content by injecting isolated N₂ into a general-purpose mass spectrometer rather than a specialized isotope ratio mass spectrometer.

The process can be conducted in a batch mode to produce a convectively mixed N₂ gas fraction that can be injected into the mass spectrometer at the convenience of the operator. Unlike dynamic flow systems of the prior art, the operation of the process and apparatus of the invention does not require critical timing of the point at which the gas stream is directed to the mass spectrometer. This obviates the need for sophisticated, typically computer driven, control systems that are necessary to identify and divert an N₂ or CO₂ fraction to the spectrometer. Moreover, the apparatus can be cleaned and reused a large number of times, e.g., at least 5, ordinarily at least 10, more typically at least 50, and often at least 100 times before it must be discarded or overhauled.

The system is particularly adapted for the determination of ¹⁵N/¹⁴N ratios in condensed phase nitrogenous compositions, especially solid organic compositions of relatively low vapor pressure. A prominent application is for analysis of the ¹⁵N content of proteins, peptides, mixtures of proteins and peptides, lyophilized biological cells, algal cells, or a tissue specimen, but the process is also well adapted for the determination of ¹⁵N in chemically synthesized compositions of relatively low vapor pressure such as nitroanilines, nitrophenols, phthalimides, phenylene diamines and/or other nitrogenous aromatic compounds. ¹⁵N-bearing amino acids are also subject to analysis according to the process of the invention. More generally, the process might be adapted for ¹⁵N-determination of solid-phase compositions that include amines, amides, nitro group chemicals, nitrogenous heterocycles, enzymes, purines, pyrimidines, and select drugs. In various preferred applications, the composition subject to analysis is substantially in the solid phase at 100° C. and/or has a vapor pressure less than about 10 mm Hg, preferably less than about 1 mm Hg, at 100° C. and/or has an atmospheric boiling point greater than about 175° C., preferably greater than about 200° C.

Biosynthesized proteins, biosynthesized peptides, algal lyophilized cells, other cellular samples, tissue culture or other tissue specimen and other nitrogenous organic compounds or specimens are often solvated with residual solvent used in their preparation. Although they are also commonly lyophilized after synthesis, lyophilization is generally effective only for removal of free solvent, not for removing bound solvent that may be bonded to the nitrogenous product via hydrogen bonding or the like, and/or present as inclusions embedded within the solid mass. In various preferred embodiments of the process of the invention, a specimen of the composition is desolvated prior to combustion thereof.

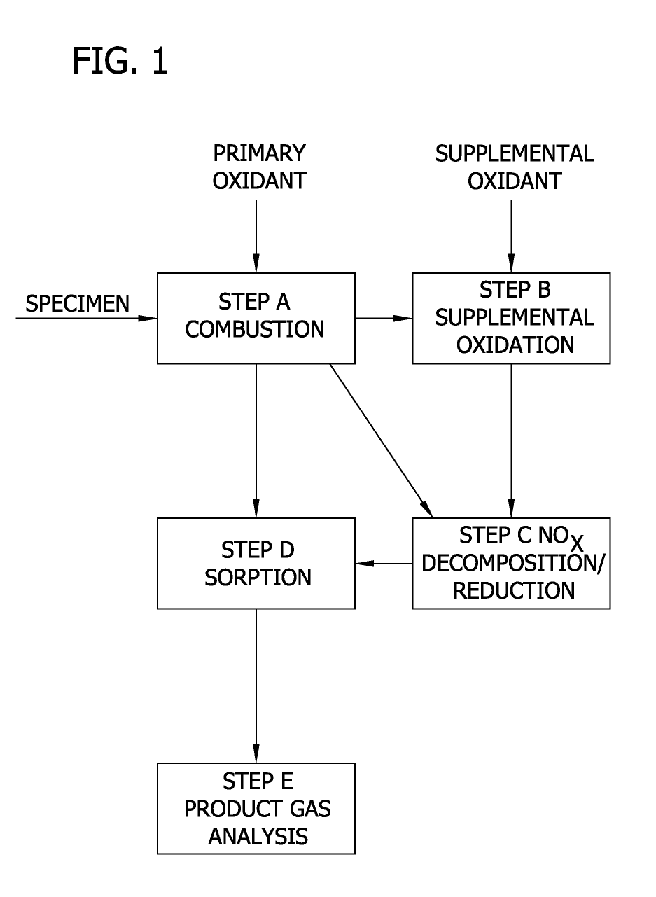

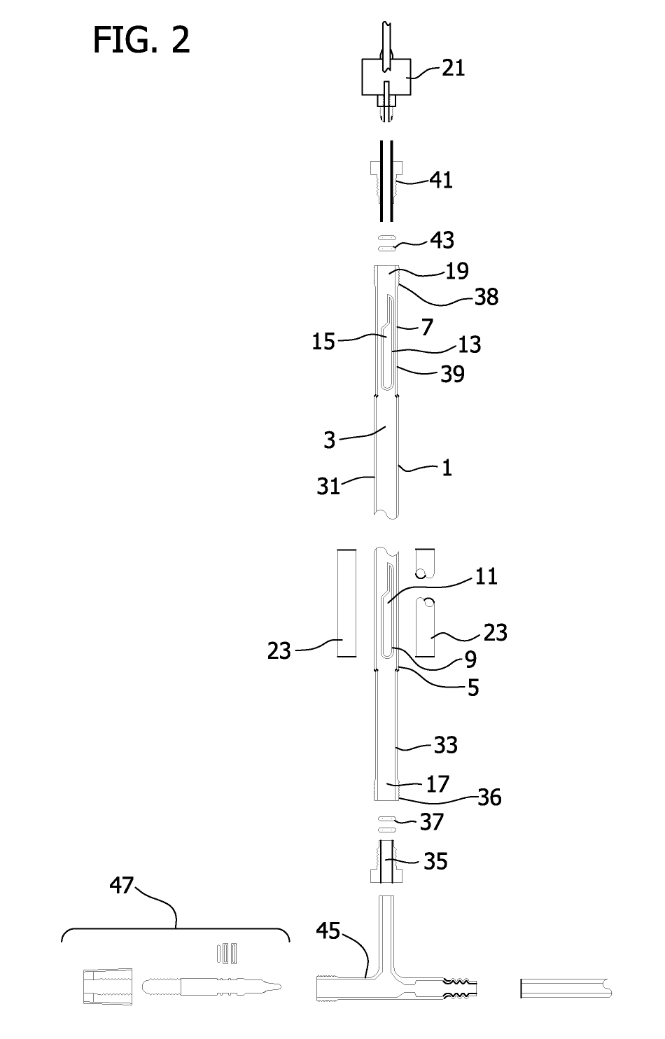

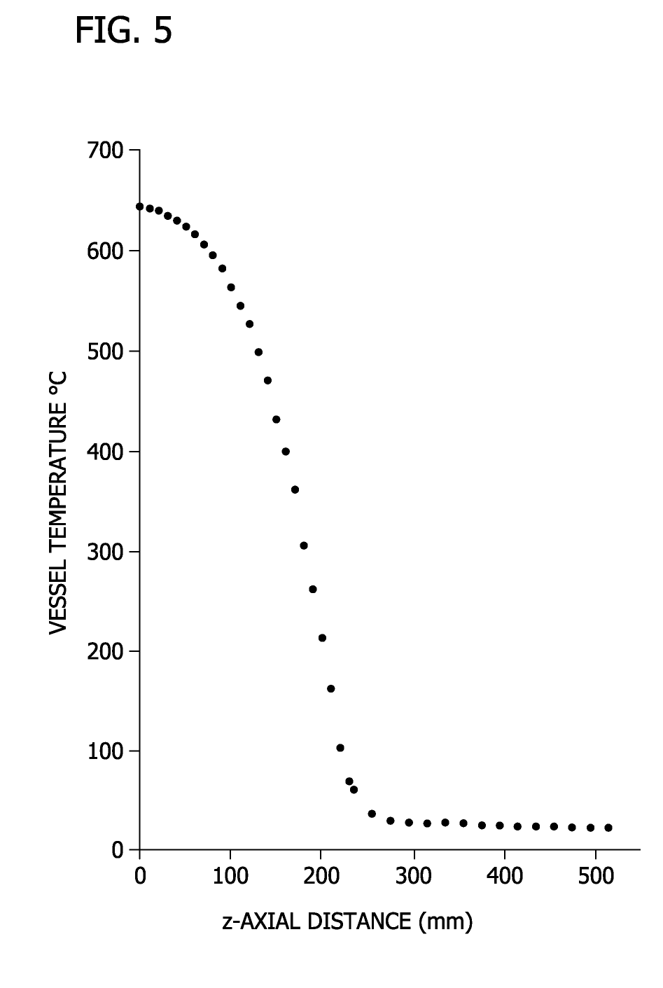

FIG. 1 schematically illustrates a preferred embodiment of the process invention. Although FIG. 1 is depicted as a flowsheet, the process is preferably conducted in a batch mode in which the various steps of the process are carried out in a single nitrogen generation and isolation zone, e.g., a space within a single compartment or chamber in a process vessel of the type illustrated in FIG. 2. Where the specimen is solvated, especially where it is solvated with a nitrogenous reagent such as acetonitrile, pyridine, dimethylformamide, triethylamine, ethylenediamine, or ammonium hydroxide, the specimen is preferably first desolvated (step A) either under reduced pressure, by heating, or by a combination of reduced pressure and heating. A primary oxidant, preferably molecular oxygen, is then introduced into the nitrogen generation and isolation zone and brought into contact with the specimen in a combustion region of the N₂ generation and contact zone (step B). Combustion of the specimen generates a combustion product gas comprising CO₂, water vapor and N₂. Combustion need not be complete, so long as sufficient N₂ is generated for purposes of isotopic analysis. In a sorption region spaced from the combustion region within the generation and isolation zone, the combustion product gas is contacted with a sorbent (step D) for sorption of water vapor and CO₂ from the gas phase. As illustrated in FIG. 5, a substantial temperature gradient prevails along the longitudinal axis of the generation and isolation zone during combustion of the specimen, so that the sorption region is ordinarily at a temperature well below the combustion temperature. Contact of the combustion product gas with the sorbent at such lower temperature enables sorption of water vapor and CO₂ from the gas phase, thus yielding a nitrogen gas fraction that may be analyzed for ¹⁵N/¹⁴N content.

In many if not most instances, the combustion product gas may also at least nascently contain CO and NOₓ. Especially where solid specimens are combusted, carbon contained in specimen compounds may not be fully oxidized, especially at the modest ratios of oxygen to specimen described below. Moreover, under the prevailing combustion conditions, CO₂ tends to dissociate to yield equilibrium proportions of CO and O₂. In various preferred embodiments, as described below, a supplemental oxidant is provided to oxidize CO to CO₂. The supplemental oxidant may be provided within the combustion region where oxidation of CO to CO₂ proceeds (step B). As described below, contamination with NOₓ has generally proven not to be a major problem in conducting the process using the apparatus of the invention. It is believed that NOₓ may be reduced (step C) by reaction with transient NHₓ, or by reaction with transient CHₓ, or by reaction with carbon char produced by incomplete combustion of the specimen. Optionally, however, the gas phase may be contacted with a reductant for NOₓ in a reduction region within the generation and isolation zone and spaced from both the combustion region and the sorption region. Where a reductant for NOₓ is used, the NOₓ reduction region is preferably positioned within the generation and isolation zone at a location where a temperature effective, more preferably optimal, for NOₓ reduction may prevail during combustion, i.e., a location along the temperature profile of FIG. 5 that is optimal for the purpose. Conveniently, the reduction region is positioned between the combustion region and the sorption region, either adjacent or near to the former. Alternatively, the reduction region may be on the side of the combustion region opposite from the sorption region, i.e., the combustion region may be positioned between the reduction region and the sorption region. Those skilled in the art can readily determine an optimal location of the reduction region based on the typical longitudinal temperature profile during combustion. Preferably a relatively small quantity of reductant is used, to minimize or avoid generation of hydrocarbons or hydrogen gas. For example, the quantity of reductant may be equivalent to between 0% and about 35%, more typically between about 1% and about 15%, of the carbon content of the specimen. Any convenient reductant may be used for reduction of NOₓ, e.g., iron powder, copper powder, nickel powder, or platinum/rhodium on alumina.

Over the course of reaction and sorption, the composition of the gas phase equilibrates to a steady-state condition at which water and CO₂ are substantially extinguished.

Free-convective mixing of the gas phase within the space defining the generation and isolation zone yields a nitrogen gas fraction of substantially steady-state and uniform composition within the generation and isolation zone, typically within the single chamber of the process vessel of FIG. 2, that is preferably closed during combustion and sorption against the introduction of any gas that is not subject to sorption in the sorption region of the zone. At the operator's convenience, the process vessel may be transported to the location of an off line mass spectrometer and the gas fraction contained in the vessel, or more typically a sample thereof, may be injected into the gas inlet port of the spectrometer for analysis of the relative proportions of ¹⁵N and ¹⁴N in the gas fraction, which is reflective of the relative proportions of nitrogen isotopes in the specimen subjected to combustion. Because the nitrogen gas fraction is generated on a batch basis, precise gas transfer timing between process vessel and mass spectrometer is not critical. The spectrometer into which the sample is injected may comprise a general-purpose quadrupole. A specialized isotope ratio mass spectrometers is not required.

FIG. 2 illustrates an apparatus of the invention which comprises a tubular process vessel 1, the interior of which defines an N₂ generation and isolation zone 3 comprising discrete combustion and sorption regions 5 and 7, respectively. Within combustion region 5 is a combustion station 9 comprising a quartz boat 11 holding a specimen of the composition to be analyzed. Quartz boat 11 may also contain a supplemental oxidizing agent for oxidizing CO generated in the combustion to CO₂ and also an optional reductant. Within sorption region 7 is a sorption station 13 comprising another quartz boat 15 holding a sorbent for CO₂ and water vapor. At or near one end of the tubular process vessel, typically on the side of the combustion region opposite from the sorption region, is a gas flow port 17 comprising an internally threaded socket 36 (integrally fused with vessel 1) for inflow of a primary oxidant gas and outflow of the nitrogen gas fraction produced by combustion of the specimen and sorption of CO₂ and water. As described below, the vessel may also be evacuated and/or volatile contaminants such as a bound solvent removed via port 17. At or near the other end of process vessel 1 is a secondary access port 19 comprising an internally threaded socket 38 that can optionally and alternatively be either plugged or connected to a pressure transducer 21. In the embodiment of FIG. 2, both combustion station 9 and sorption station 13 are located between socket 36 and socket 38 with respect to the longitudinal axis of the process vessel 1. Thus, the generation and isolation zone is formed within a single chamber which may be closed during combustion and sorption against the introduction of any gas that is not subject to sorption in said sorption region, and which is typically also closed against removal of gas during the combustion phase of the operation.

The combustion region 5 of generation and isolation zone 3 within tubular process vessel 1 is surrounded by a heat source, e.g., an electrical resistance furnace 23 such as a Carbolite MTF 12/38/400 furnace, which is effective for heating the specimen in boat 11 to its reactive temperature. The furnace is adapted to supply heat substantially to the combustion region so that the sorption region 7 may be maintained at a lower temperature suitable for sorption of components such as CO₂ and water vapor from the gas phase.

During combustion, there is a net flow of gas from the combustion region to the sorption region. However, the spacing between the combustion region 5 and the sorption region 7 relative to the diameter and wall thickness of the tubular vessel is preferably such that environmental heat losses alone establish an axial thermal gradient along the longitudinal axis of the vessel sufficient that the sorption region is at a temperature low enough for effective sorption of CO₂ and water vapor. FIG. 5 illustrates a typical gradient wherein the temperature decreases progressively from greater than 350° C., e.g., about 650° C., in the combustion region to well below 100° C., e.g., about ambient, in the sorption region.

Further salient features of the apparatus are described hereinbelow, following detailed description of the process.

In carrying out the process of the invention, a specimen of a condensed phase composition to be analyzed, typically a solid specimen, is introduced into the combustion region within the generation and isolation zone, e.g., by placement in boat 11 within vessel 1. Often, the condensed phase composition comprises volatile components, for example a bound reagent that can cause complications in the analysis. In preferred embodiments of the process, such volatile components are removed by controllably heating the specimen region, exposing it to a low pressure atmosphere, or both. Preferably gas flow port 17 is connected in gas flow communication to a vacuum pump or ejector via an adjustable orifice (such as a metering valve), and the pressure dynamically reduced to and maintained at less than about 1 torr, preferably less than about 0.1 torr, while heat is supplied by furnace 23 to promote removal of volatiles. Usage of an adjustable valve between process vessel 1 and an external vacuum source limits the movement of intravessel materials during vessel evacuation. The temperature of the specimen during removal of volatiles is typically in the range between about ambient and 250° C. Removal of volatiles may generally require exposure to vacuum conditions for a period of about 1 to about 50 hours.

Preferably, a sorbent is loaded into boat 15 in sorption region 7 prior to evacuation of the generation and isolation zone 3 for removal of volatiles from the specimen. Where this procedure is followed, the sorbent is degassed during the vacuum heating phase. Degassing the sorbent functions primarily to remove air. Removal of air is desirable inter alia to avoid contamination of the product nitrogen fraction with nitrogen from the air. Where a supplemental oxidant is used, e.g., a metal oxide as described below, vacuum heating of the combustion region prior to combustion may serve the further purpose of increasing supplemental oxidant activity by removing adsorbed impurities and converting metal carbonate to metal oxide.

To carry out the combustion step, a primary oxidant, preferably molecular oxygen, is introduced into the generation and isolation zone. Other oxidants, e.g., Cl₂ or O₃, may be used in some circumstances, but molecular oxygen is highly preferred. The oxygen charge is preferably substantially dry, i.e., containing less than about 1% by volume, preferably less than 0.1% by volume, more preferably less than 0.01% by volume water vapor, and substantially pure, containing at least about 99% by volume, preferably 99.9% by volume, more preferably at least about 99.995% by volume O₂. In order to minimize the presence of nitrogen from air, the generation and isolation zone is preferably evacuated prior to admission of oxygen, irrespective of whether evacuation is necessary for removal of undesired volatiles from the specimen. Oxygen is thereafter charged to any convenient pressure, for example, 10 to 1000 torr (absolute), more typically about 200 to about 700 torr (absolute). After oxygen is admitted, heat is applied by furnace 23 to heat the specimen to its reactive temperature in contact with oxygen, thus generating a combustion product gas comprising CO₂, water vapor, and N₂. Combustion may typically be conducted at a temperature between about 350° and about 1000° C., more typically between about 500° and about 800° C. A modest exotherm is typically expected during combustion. For example, if the furnace is controlled to bring the temperature of the specimen to a temperature in the range of 500° C. to 750° C. for reaction, the exotherm may typically involve an additional 0.5 to 5 kilojoules for organic combustions. Gradual low-temperature combustion contrasts with GC-IRMS, which generally utilizes temperature greater than 900° C. for rapid organic combustion. Thus low-temperature combustion significantly simplifies process vessel design and the selection of construction materials. Optionally, a thermocouple (not shown) may be placed in contact with the outer wall of vessel region 5 or even more proximal to boat 11, and the heat generation by furnace 23 controlled in response to the combustion region temperature via a temperature controller (not shown) in order to initiate combustion at a target temperature. However, in routine repetitive processing of specimens of similar composition, furnace output can be controlled based on process operating experience without need for a temperature control loop in solid contact with vessel or specimen. It will be understood by those skilled in the art that if desired, other apparatus controllers may be additionally incorporated into the apparatus without departing from the scope of the invention (such as timer controller, mass flow controller, pressure controller, valve controller, programmable logic controller, or microprocessor).

Complete combustion of the specimen is not necessary. In fact, the process can proceed satisfactorily where the combustion phase actually comprises a combination of oxidation and pyrolysis, yielding not only CO₂, water and CO as products of combustion, but also hydrogen and carbon under particular conditions. Thus, e.g., the quantity of the specimen relative to the volume of the generation and isolation zone, i.e., the interior of tubular process vessel 1, may be such that a charge of 100% molecular oxygen occupying this zone at 25° C. and 500 torr (absolute) would be stoichiometrically equivalent to about 10% to about 150% of the carbon content of the specimen. The specimen is sized and molecular oxygen charged at such pressure that the measured signal magnitude for dioxygen in the process vessel after combustion/sorption is preferably less than about 50%, more preferably less than 5%, and still more preferably less than 1% of the signal magnitude for product dinitrogen.

Preferably, there are no significant flow restrictions between the combustion and sorption regions, nor otherwise within the N₂ generation and isolation zone. More preferably, as shown, the combustion and sorption regions are contained within a single chamber. As a consequence, no significant pressure drop is observed in flow of gas from the combustion region to the sorption region, and sorption is typically initiated during the combustion phase. As combustion and sorption progress, the generation and isolation zone becomes substantially back mixed via free convection between the combustion and sorption regions, and typically throughout the entire zone. The total pressure within the generation and isolation zone is typically in the range of about 10 and about 1000 torr, more typically between about 25 and about 1000 torr, or between about 200 to about 800 torr, during the combustion and sorption cycle. During combustion, the peak pressure may typically be in the range of 100 to 1000 torr, more typically 500 to 1000 torr, decaying to 10 to 500 torr, more typically 25 to 300 torr as CO₂ and H₂O vapor are sorbed and N₂ becomes the major gaseous product. A modest positive gauge pressure can assist in preventing ingress of air during combustion and sorption. For example, where molecular oxygen is introduced into the process vessel 1 at an absolute pressure in the range of 400 to 600 torr, peak pressure may be reached at 550 to 1000 torr, after which the pressure declines due to gas depletion and/or slowing of the combustion rate. Where combustion and sorption are conducted in a batch mode, the overall batch cycle is typically between about 2 and about 50 hours.

Preferably, a supplemental oxidant is provided to promote oxidation of CO generated in the combustion. Conveniently, the supplemental oxidant may be present in the combustion zone, e.g., mixed with the specimen in boat 11 at combustion station 9. In such embodiments, the supplemental oxidant may be mixed with the specimen prior to introduction of the specimen into the combustion region, or mixed with the specimen at the combustion station, e.g., in boat 11, prior to combustion, and ordinarily prior to vacuum heating for removal of volatile components from the specimen. Alternatively, a separate station may be provided comprising a holder for the supplemental oxidant. Preferably, the supplemental oxidant is a metal oxide such as a transition metal oxide, typically in particulate form with particle size preferably less than about 0.1 mm. Exemplary suitable supplemental oxidants include Fe₃O₄, CuO, CO₃O₄ and NiO. Peroxides are generally not preferred as supplemental oxidants. The supplemental oxidant functions directly as an oxidizer, but may also have some catalytic effect in promoting conversion of CO to CO₂. Preferably the specimen, or a mixture of specimen and supplemental oxidant, is mechanically pulverized prior to introduction into the process vessel. Preferably, the specimen and supplemental oxidant may be mixed in a weight ratio between 10:1 and 1:10, more preferably between 5:1 and 1:5, still more preferably between 2:1 to 1:2, and typically in the neighborhood of 1:1.

The sorption region may comprise a plurality of sorption stages, but does not require a multi-stage separation system such as a chromatographic column. Ordinarily, not more than three sorption stages are needed and, regardless of the number of stages, the sorption region gas-phase is typically fully convectively mixed. Preferably, sorption is conducted in a single stage using a sorbent that is effective for sorption of both water and CO₂. Preferably, contact between the gas phase and the sorbent is effected by allowing the gas to flow over the sorbent bed, e.g., by placing the sorbent in boat 15, rather than through the sorbent bed as in a conventional fixed bed adsorber or packed column. In this way, plugging of flow path is avoided, pressure drop across the sorbent region is minimized, and free convective gaseous mixing is promoted within the generation and isolation zone.

Any convenient sorbent may be used. It will be understood that the sorption station may comprise an adsorbent, an absorbent, or both. Preferred sorbents include alkali metal oxides such as lithium oxide, sodium oxide and potassium oxide, preferably in an anhydrous state as charged to the sorption station. Lithium oxide is a particularly preferred sorbent. While other sorbents such as magnesium perchlorate can be used if desired, it is generally preferred that strong oxidants not be used. Typically, the solid sorbent may consist of particles sized less than 0.5 mm. Without being limited to any single theory, it is believed that dry alkali metal oxide sorbents may function as either adsorbents or absorbents. Under initial gas/solid contact, the dry alkali metal oxide may function primarily as an adsorbent. However, once an alkali metal oxide sorbent has sorbed a modest quantity of water, a caustic mixture may be formed at the sorption station which can function as an absorbent for both CO₂ and water.

If desired, separate sorbents may be provided at separate sorption stations for CO₂ and water vapor, respectively, within the sorption region. For example, water can be absorbed by either BaO or P₂O₅, and CO₂ sorbed in a soda/lime mixture in a separate sorption station. Where the specimen contains sulfur, a sorbent effective for removal of SOₓ is preferably provided. Certain metal oxide sorbents are effective for SOₓ removal, for example CaO (quicklime). Where reactive absorption is involved, e.g., between CO₂ and/or SOₓ and alkaline metal hydroxide solution, the quantity of sorbent is preferably at least stoichiometrically equivalent to the total carbon, hydrogen, and sulfur contained in the specimen. Typically, an alkali metal oxide is provided in an excess ratio of at least ten, more typically at least fifteen, with respect to the sum of carbon, hydrogen, and sulfur. If a separate sorbent is provided for water, such as BaO or P₂O₅, it is preferably provided in stoichiometric excess vs. the hydrogen content of the specimen.

The process and apparatus of the invention enable recovery of a nitrogen gas fraction that is substantially devoid of CO₂ without the necessity of using a cold trap. Avoidance of cold traps significantly simplifies the apparatus and operation of the process. However, it will be understood by those skilled in the art that, if desired, a containment module could be provided, either within the tubular process vessel (for example the said module may be sealingly connected via port 19), or as an appendage to the vessel (for example said module may be sealingly connected via port 19), or connected between process vessel and spectrometer during discharge of the nitrogen gas fraction to a mass spectrometer, or in a combination of two or more such arrangements. The use of a sorbent is highly preferred for most applications, and the removal of CO₂, H₂O, and SOₓ by sorption rather than by cold trap represents a significant advantage of various preferred embodiments of the present invention.

The generation and isolation zone within tubular process vessel 1 is preferably configured so that environmental heat losses during combustion cause sorption to take place at a temperature less than 100° C., preferably less than about 50° C., typically at ambient or slightly above. Optionally, the sorption region may be cooled by forced circulation of ambient air around the portion of the tubular process vessel surrounding the sorption region, or by circulation of another cooling fluid, e.g., cooling water or coolant gas through an annular jacket surrounding the sorption region. The pressure in the sorption region is essentially the same as in the combustion region, i.e., during the combustion phase, it may typically rise early in the process to a peak level in the range 550 to 1000 torr, then drop back, e.g., to a level in the range of 10 to 500 torr as gaseous material is sorbed. Pressures in these ranges are generally suitable for effecting sorption of CO₂ and water vapor.

Because combustion is practically conducted with a slight deficiency or slight excess of oxidant, combustion of the specimen is not necessarily complete. Typically the specimen may partly char during combustion instead of being entirely consumed. Under such conditions, most NOₓ generated during the combustion may typically be reduced by reaction with carbon, transient CHₓ species, or transient NHₓ species produced by charring the specimen. The presence of H₂ has been conditionally observed in the product dinitrogen gas fraction, indicating that hydrogen species could also have a role in reducing NOₓ or inhibiting its formation. Moreover, within a preferred combustion temperature range, e.g., 500° C. to 750° C., even nascent NOₓ formation may not be favored. In any event, the nitrogen gas fraction appropriately produced in accordance with the invention does not typically contain any substantially interfering fraction of NOₓ. In addition to the potential function of carbon char, CHₓ species, NHₓ species, and/or hydrogen as reductants, a metal oxide used as a supplemental oxidant may conceivably function as a catalyst for the decomposition of NOₓ to N₂ and O₂. As a still further possibility, some NOₓ might be captured in the sorption region by the sorbent for water vapor and CO₂. However, there is no analytically significant isotope effect of whatever NOₓ may be sorbed.

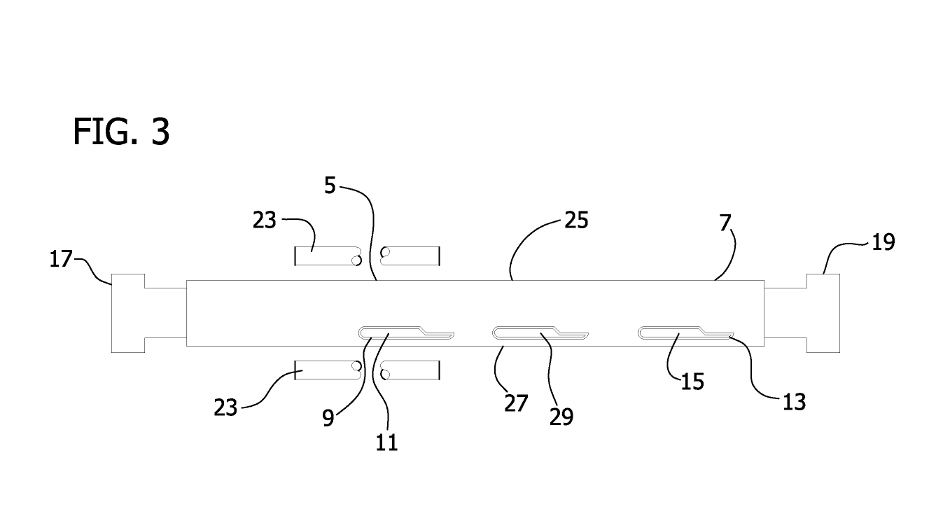

Alternatively, as illustrated schematically in FIG. 3, a reduction region 25 may be established in the generation and isolation zone containing a reductant for reduction of NOₓ to N₂. Such a reduction region is preferably spaced from both the combustion region and the sorption region, and typically is positioned therebetween. Referring to FIG. 3, the reduction region 25 comprising a reduction station 27 is located along the longitudal axis of the generation and isolation zone within the tubular vessel 1 at a location wherein the thermal gradient establishes temperature that may be optimal for the reduction of NOₓ. Typical reductants that may be provided at reduction station include iron powder, copper powder, nickel powder, or platinum/rhodium on alumina, which may typically be held at the reduction station in boat 29. Preferably, the reduction region is so located that the temperature within that region during combustion is between about 400° C. and about 750° C.

As combustion and sorption proceed, the gas phase equilibrates by free convective axial (longitudinal) and radial back mixing so that the composition of the gas phase becomes substantially steady-state throughout the generation and isolation zone. After the combustion and sorption steps are complete, a product dinitrogen gas fraction is obtained wherein the sum of the water vapor content and CO₂ content is not more than about 5 volume %, preferably not more than 1 volume %, and more preferably not more than 0.5 volume %. Preferably, the carbon monoxide content is not more than about 0.5 volume %, more preferably not more than about 0.2 volume %. It is preferable to establish both a low CO content and a low CO₂ content, especially for higher precision determinations because at typical ionization conditions CO₂ tends to fragment into CO and oxygen in a mass spectrometer. While ¹²C¹⁶O₂ as such, which has a nominal mass of 44, does not interfere with the determination of ¹⁵N, any ¹²C¹⁶O (nominal mass=28) or ¹³C¹⁶O (nominal mass=29), whether present in the sample or formed within the spectrometer, has a deleterious effect. A sorbent or combination of sorbents effective for removal of both CO₂ and water is preferred because the presence of water vapor can apparently influence the process conversion of CO to CO₂. Preferably, the product nitrogen gas fraction is essentially free of NOₓ, a result that is achievable on the basis described hereinabove.

On the basis of actual process results, it is preferred that the product nitrogen gas fraction contains minimal quantitites of both dioxygen and dihydrogen (that is, minimal amounts of gaseous oxidant and reductant). Because molecular oxygen has nominal molecular masses of 32 and greater, the presence of a minor proportion of oxygen and/or hydrogen in the product nitrogen gas fraction does not directly affect mass spectral analysis. It is preferred that the molecular oxygen content be not greater than about 50 volume %, more preferred that the molecular oxygen content be not greater than 5 volume %, even more preferred that the molecular oxygen content be not greater than 1 volume %. With regard to residual hydrogen gas after combustion, it is preferred that the dihydrogen content be not greater than 5 volume % or more preferably not greater than 1 volume %.

In the system described above, an appropriate thermal gradient, such as that illustrated in FIG. 5, is achieved on a batch basis in a single N₂ generation and isolation zone, e.g., within the single chamber of a tubular process vessel, and is achieved in part by selection of process vessel geometry, as described hereinabove. Thus, the process of the invention does not require passage of the gas phase sequentially through a series of segregated temperature zones, nor does the novel apparatus need to provide for plug flow operation or precise synchronization of N₂ generation and analysis. In accordance with the description set out above, a satisfactory temperature gradient between the combustion and sorption stations may be achieved by appropriate selection of furnace power, furnace configuration, reactant quantities, and the L/D aspect of the generation and isolation zone in the tubular reactor between the combustion region and the sorption region. Positive temperature control at the specimen itself is generally not required, though if desired temperature control can be provided by placing a thermocouple near specimen boat 11 and provide a temperature controller (not shown) to regulate the power input to furnace 23 in response to a signal from the thermocouple to control local temperature in the combustion region during vacuum heating and/or combustion. Based on these principles, those skilled in the art may readily select appropriate dimensions for the tubular process vessel and spacing of sorption region from the combustion region therein, and thus to establish a desired temperature profile along the longitudinal axis of the generation and isolation zone within a tubular process vessel, such as, for example, the profile illustrated in FIG. 5.

It will be understood that FIG. 5 illustrates intravessel temperature profile with respect to distance along the longitudinal axis at a time prior to any substantial chemical reaction. A plot might also be prepared of the temperature profile with respect to reaction time at a particular point along the longitudinal axis. However, since chemical reaction is conducted on a batch basis at temperatures typically below 1000° C., the exact temperature versus time profile within the combustion region, or in the intermediate region between the combustion region and the sorption region, is not narrowly critical. Based on the design of the apparatus, as described above, environmental heat losses ensure that the sorption region either is consistently in a temperature range (see FIG. 5) whereby sorption of gaseous CO₂ and water vapor is substantial or else cools to an effective sorption temperature range during the batch cycle so that equilibration by convection within the gas phase in the N₂ generation and isolation zone results in substantial sorption of CO₂ and water vapor components of the gas phase by the completion of a process cycle.

After the combustion and sorption cycle is complete, the process vessel containing the product nitrogen gas fraction may be wheeled to the location of a mass spectrometer, and a sample comprising at least a portion of the nitrogen gas fraction introduced into the injection port of the spectrometer. The ¹⁵N-isotopic content of the sample, and thus of the nitrogen contained in the specimen, is ordinarily determined from mass spectrometric signals observed at nominal m/z ratios 30, 29, and 28 (N₂⁺), though it is conditionally conceivable that spectrometric signals at nominal m/z ratios 15, 14.5, and 14 (N₂²⁺) might instead be utilized for ¹⁵N-determination. It has been found that, when the apparatus of FIG. 2 or 3 is operated in accordance with the process of the invention under preferred conditions, the net spectrometric signal for ¹⁵N₂⁺ (m/z 30) is typically more than twenty times greater than the combined signals for ¹²C¹⁶O₂⁺ (m/z 44) and water vapor (m/z 18) However, as those skilled in the art will understand, the presence of minor fractions of CO₂, water, NOₓ and/or SOₓ does not prevent the process and apparatus from providing useful data on ¹⁵N content and/or ¹⁵N/¹⁴N ratio.

Referring again to the apparatus as depicted in FIG. 2, tubular process vessel 1 is preferably constructed of glass, in several separate segments. A tubular combustion region segment 31 surrounding combustion station 9 is preferably constituted of a glass such as fused silica glass that is capable of withstanding combustion temperatures in excess of 500° C., preferably in excess of 750° C. A tubular transition glass segment 33 is fused at its inward end to combustion region segment 31 and at its outward end to gas flow socket 36. Socket 36 is conveniently constructed of borosilicate glass, and may be threaded (either internally as shown or externally) for connection to a vacuum source, molecular oxygen source, gas manifold or gas analyzer. In the apparatus as shown, socket 36 is adapted for threaded connection to a flanged bushing 35 that is in turn adapted for connection to tee 45 leading to the vacuum source, molecular oxygen source, gas analyzer or gas manifold. At its inward end (where it is fused to the combustion segment), the composition of the transition glass segment is such that any difference between its coefficient of thermal expansion and that of the combustion region segment is small enough so that the joint between the combustion region segment and the transition segment remains substantially stable when the combustion region is repetitively cycled between ambient temperature and peak combustion temperature, e.g., between ambient temperature and 500° C., or 650° C., or 750° C. The transition segment may be entirely constituted of a uniform glass composition, or may be comprised of a plurality of segments of differing composition which are fused together.

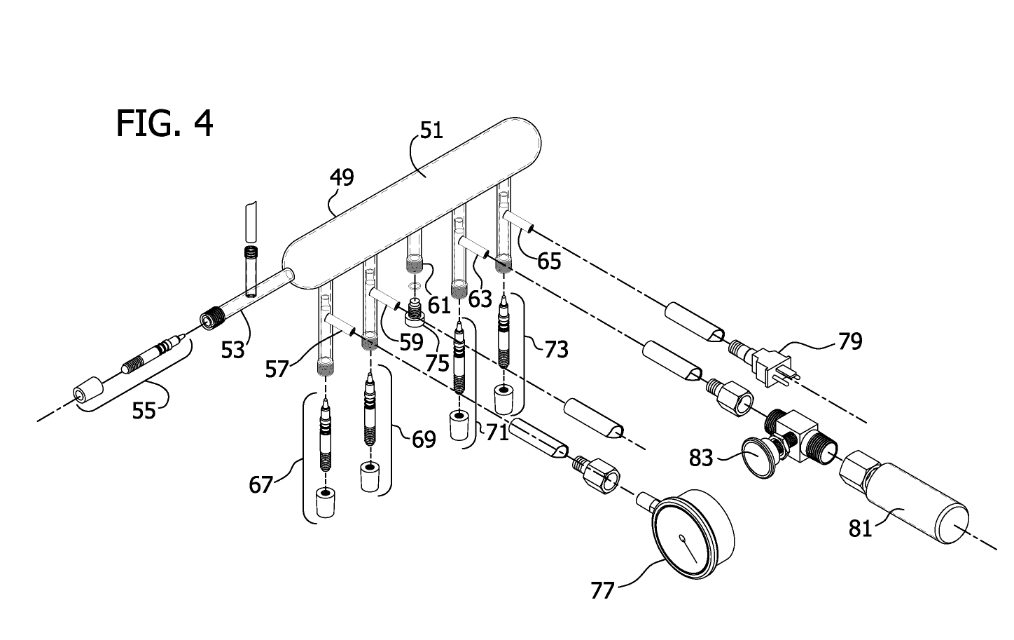

One or more O-rings 37 may assist in hermetically sealing the connection between socket 36 and bushing 35. The primary gas port 17 comprising socket 36 is adapted for gas flow connection to a source of molecular oxygen, a gas analyzer, a vacuum source or a gas manifold such as that illustrated in FIG. 4. Structurally, bushing 35 comprises a flange, threaded socket or threaded nipple adapted for direct connection to a mating flange, threaded nipple or threaded socket on a conduit which provides gas flow communication between process vessel 1 and a source of molecular oxygen, a gas analyzer, a vacuum source or a gas manifold.

Combustion region segment 31 preferably extends beyond combustion station 9 in both longitudinal directions, i.e. in the direction of both port 19 and port 17. This dual extension typically extends outside the region to which heat is actively supplied by furnace 23, and thus provides intermediate regions within which the temperature may progressively decrease from peak combustion temperature to a temperature approaching the sorption temperature during the combustion period, as illustrated in FIG. 5. If the apparatus includes a reduction station 27 as illustrated schematically in FIG. 3, the reduction station and boat 29 for holding a reductant are preferably contained within this extension of the tubular combustion region segment. Another tubular transition glass segment comprising a sorption region segment 39 is fused to the combustion region segment 31 at the end of latter segment opposite its connection to transition segment 33. At the inward end of transition segment 39 (where it is fused to the combustion segment), the material of construction of segment 39 is such that any difference between its coefficient of thermal expansion and that of the combustion region segment is small enough that the joint between the combustion region segment and the transition segment remains substantially stable when repetitively cycled through successive combustion cycles (in practice an individual vessel has exceeded 100 process cycles). As indicated in FIG. 5, however, the maximum temperature attained within sorption region 7 is typically substantially lower than the maximum temperature reached at the joint between combustion region segment 31 and sorption region segment 39.

Secondary access port 19 comprising threaded socket 38 at the outer end of sorption region segment 39 is adapted for direct connection to a threaded and flanged bushing 41. The latter connection may be established with the assistance of one or multiple O-rings 43. By appropriate combination of tube, bushing, O-ring, and socket subassemblies, the apparatus of the invention is effectively sealed against influx of contaminating air, without the necessity of vacuum grease.

Tee 45 (FIG. 2) may be connected in fluid communication with the interior chamber defining the N₂ generation and isolation zone 3 within process vessel 1 for delivery of primary oxidant (O₂) and to provide connection to a vacuum source (not shown) for evacuation of the vessel during vacuum heating of the specimen and/or for removal of air prior to introduction of oxygen. As illustrated, the side run of tee 45 is adapted for connection to process vessel 1, one end of the straight run is adapted for stem accommodation of metering subassembly 47, and the other end of the straight run is for connection to either a gas manifold 49 (e.g., manifold 49 of FIG. 4) or a gas analyzer. Metering subassembly 47 may serve to regulate the introduction of oxygen prior to combustion, and as a block valve to isolate the chamber within process vessel 1 from introduction of any extraneous gases during the combustion and sorption phases of the process. Although not shown, another metering valve may serve to connect the chamber via port 19 to a containment module containing condensed-phase nitrogenous specimen, or to other extra-vessel devices, or to isolate the chamber from the vacuum source and/or other extra-vessel gases prior to introduction of oxygen.

Illustrated in FIG. 4 is a gas manifold 49 which may be connected in fluid communication with process vessel 1 to alternately or simultaneously provide several different functions, i.e.: (i) delivery of primary oxidant to the N₂ generation and isolation zone 3; (ii) connection of the chamber to a vacuum source; and (iii) measurement of pressure within the manifold, which essentially reflects the pressure within the tubular process vessel when manifold and vessel are connected and valving between them is open. Manifold 49 comprises a header 51 having a tee 53 at one end thereof. The side run of tee 53 is adapted for connection to a vacuum source while the straight run of the tee opposite the header is adapted for stem accommodation of metering subassembly 55. Thus, gas manifold 49 provides an alternative flow path for providing vacuum service to process vessel 1 or for providing gas flow communication to process vessel 1.

Referring to FIG. 4, each of a plurality of side arms 57, 59, 63 and 65 connects to a correspondent header arm, subject to access or closure via metering subassemblies 67, 69, 71 and 73. As needed, header arm 61 can be either sealed with plug 59 or otherwise employed. Further connections via these valves and side arms enable the manifold to provide the various functions mentioned above. For example, a compound pressure gauge 77 is shown as connected via subassembly 67 through side arm 57, an electronic tube 79 for communication with a thermal conductivity gauge is shown as connected via subassembly 73 through side arm 65, and an oxygen supply cylinder 81 is shown as connected through cylinder valve 83, metering subassembly 71 and side arm 63. A thermal conductivity gauge may be used for low pressure measurement during evacuation and vacuum heat treating of the specimen. Side arm 59 is typically connected via subassembly 69 to one straight run port of tee 45, while header arm 61 is closed by plug 75.

It has been found convenient for process vessel 1 to have an internal volume in the range of 0.02 to 2 liters, more conveniently 0.05 to 0.5 liters, advantageously between about 0.1 and about 0.25 liters. In such instance, the amount of specimen charged to combustion station 9 may typically be in the range between about 15 mg and about 1.5 g, more typically between about 25 mg and about 500 mg, most typically between about 50 mg and about 250 mg, where O₂ is initially charged to a pressure of about 100 to about 800 torr. The supplemental oxidant charge is preferably within the range between about 5 mg and about 1.5 g, between about 50 mg and about 500 mg, or between about 100 and about 250 mg. At the scale defined by the aforesaid quantities of specimen and a preferred L/D aspect ratio between about 10 and about 250 including the combustion region and the sorption region, the distance from combustion station 9 to sorption station 13 is preferably between about 5 cm and about one meter, more preferably between about 10 cm and about 75 cm, more typically between about 15 cm and about 50 cm.

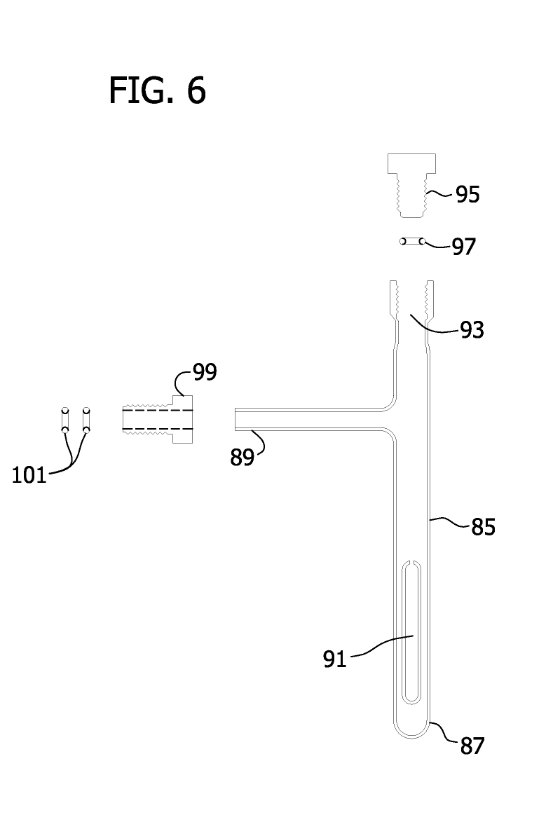

Illustrated in FIG. 6 is a specimen containment module 85 adapted to be attached in fluid flow communication with secondary access port 19 of the tubular process vessel as illustrated in either FIG. 2 or FIG. 3. The module comprises a tubular container 87 having a sidearm 89 for communication with the interior of process vessel 1. Typically, container 87 is disposed vertically. A holder 91 for a condensed phase specimen is located within the lower leg of container 87 below the level of sidearm 89. The container has a port 93 at its upper end for introduction of a specimen. Holder 91 is preferably removable from the container so that the specimen can be placed in the holder outside the container, after which the holder and specimen are placed inside the container. Port 93 may be threaded (internally as shown in the drawing, or externally) to receive a plug 95 comprising a threaded plug (as shown) or cap to close the module after the specimen is introduced. The closure is conveniently sealed with an O-ring 97. The sidearm may be connected to a threaded socket at secondary access port 19 via a bushing 99 sealed with O-rings 101. In practice, a volatile specimen might be loaded into holder 91, the charged holder then placed inside container 87, port 93 sealed, and sidearm 98 sealingly attached to vessel 1. By controlled cooling of the lower container leg 85, said volatile specimen may be condensed (thus contained) so that such condensed specimen can be vacuum degassed prior to any oxygen addition. Afterward, an auxiliary heater (not shown) might be utilized to vaporize the specimen which then flows through sidearm 89 into the interior of tubular process vessel 1 wherein it is combusted as described above. The reaction product gas is convectively back-mixed axially within process vessel 1. Optionally, the vaporized specimen may be convectively back-mixed with oxygen axially of the process vessel prior to initiation of combustion. CO₂ and water are sorbed by sorbent contained by boat 15. As necessary, process vessel 1 may contain a reductant in boat 29 as illustrated in FIG. 3 for NOₓ decomposition.

The apparatus and process of the invention are adapted for conducting a relatively high volume of repetitive isotopic determinations. After each combustion and sorption cycle, the apparatus may be cleaned and re-used to generate and isolate another N₂ fraction. The interior of the vessel and the quartz boats may be cleaned with a brush and abrasive, after which fresh sorbent may be supplied to the sorption station and a new specimen, typically mixed with fresh supplemental oxidant, may be supplied to the combustion station. By use of boats for specimen and sorbent, the apparatus may be readily re-used without laborious repacking of reactors, sorption columns, and the like. Moreover, the process vessel/furnace module can be mobile thus easily transported and attached to available analyzers and manifolds. The unified reactor/sorption process pipe is refractory, transparent and grease-free. Greaseless connections eliminate any possible isotopic contamination from grease usage and they facilitate apparatus cleanup and re-use.

The use of boats for specimen, supplemental oxidant, sorbent and reductant minimizes movement of any of these materials outside its proper region during combustion and sorption operations.

Gastight process vessel 1 also affords convenient storage of the nitrogen fraction pending analysis by mass spectrometry or alternative technics. For example, in higher volume operations, a plurality of process vessels may be used to generate a plurality of N₂ fractions which can be accumulated to be run successively through a single mass spectrometer. This allows the mass spectrometer to be usefully be employed in making other analyses, if desired, without comprising analyses of specimens for ¹⁵N content. The sample or accumulated samples of nitrogen gas fraction may be analyzed at any time as determined by instrumentation availability.

The apparatus and process of the invention are capable of making ¹⁵N determinations with accuracy and analytical precision. In various preferred embodiments, however, the process and apparatus of the invention are not designed for ultra-precise isotopic analysis equivalent to that provided by a GC-IRMS system. Generally, the system is adapted to determine overall ¹⁵N sample content to the nearest 0.1 atom % ¹⁵N. At this level of precision, which is entirely sufficient for most ¹⁵N-enriched commercial materials and many research applications, the apparatus can be provided at very modest cost for processing of a high volume of either routine samples or samples for which such precision is otherwise satisfactory. Because of its batch operation and lack of multi-stage adsorption, the apparatus of the invention is not typically used for determination of both carbon and nitrogen isotopic ratios on the same sample. However, if desired, the apparatus and process might be adapted to firstly measure ¹⁵N-isotopic content of a sample as described, next remove residual gases from the process vessel, and afterward desorb or by some other mechanism liberate carbonaceous gas from a sorbent at sorbent station 13 and in this manner secondly measure the ¹³C-isotopic content for the same sample.

The natural abundance of ¹⁵N is about 0.4 atom %. The process of the invention is particularly effective for determination of ¹⁵N isotope content in a specimen wherein ¹⁵N constitutes between about 5 atom % and about 99.9 atom % of the total nitrogen present. For determinations at the lower and especially at the upper end of this range, or anywhere in the range where maximum precision is desired, the water, CO and CO₂ content are preferably as low as practicable. However, over a wide spectrum within the range, and depending on the purpose and use of the analytical data, analyses of practical value may be achieved even though the nitrogen sample contains minor concentrations of CO₂, water, or even CO.

Additional logistical advantages can be afforded by the preferred use of a general-purpose mass spectrometer, such as (but not limited to) quadrupole-based spectrometers, as made feasible by the process and apparatus of the invention. Although special isotope ratio mass spectrometers can provide exceptionally high precision, they are not generally versatile, being adapted for simultaneous determination of only 3 or 4 different masses. Thus, when there is less than a constant demand for isotope ratio analyses, these highly specialized and expensive instruments may be idle. By contrast, a process gas mass spectrometer is a versatile instrument having a typical scanning range of m/z 2 to 250 or higher; and may, thus, be used in a wide variety of other applications in addition to the isotopic ratio determinations that are made according to the process of the invention.

The invention having been described in detail, it will be apparent that modifications and variations are possible without departing from the scope of the invention defined in the appended claims.

### EXAMPLES

The following non-limiting examples are provided to further illustrate the present invention.

### Example 1

### Glycine-¹⁵N

Glycine-¹⁵N specimen (0.15-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1.5-gram) was loaded into quartz boat 15 within the sorption region of the vessel. Next the secondary vessel access port was plugged, the process vesel shielded, and the reactants then subjected to dynamic vacuum heat treatment (VHT) at 75° C. for at least one hour. Subsequently about 600-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for greater than 22 hours, the reactor-furnace assembly was sealingly connected to the inlet of a quadrupole mass spectrometer. Some of the resultant product gas was metered into the mass spectrometer and analyzed. The average nitrogen isotopic result thus obtained was 99.2±0.1 atom % ¹⁵N. The chemical precursor associated with this particular glycine-¹⁵N was specified to be 99.3 atom % ¹⁵N.

### Example 2

### Biosynthesized Lyophilized Protein-¹⁵N

Biosynthesized lyophilized protein-¹⁵N specimen (0.15-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1.5-gram) was loaded into quartz boat 15 within the sorption region of the vessel. Next, the secondary vessel access port was plugged, the process vessel shielded, and the reactants then subjected to dynamic VHT at 250° C. for at least ten hours. Subsequently about 600-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for greater than 24 hours, the reactor-furnace assembly was sealingly connected to the inlet of a quadrupole mass spectrometer. Some of the resultant product gas was metered into the mass spectrometer and analyzed. The average nitrogen isotopic result thus obtained was 99.0±0.1 atom % ¹⁵N. The chemical precursor associated with this batch of glycine-¹⁵N was specified to be 99.2 atom % ¹⁵N.

### Example 3

### Nitrophenol

Para-nitrophenol specimen (0.13-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1.5-gram) was loaded into quartz boat 15 within the sorption region of the vessel. Next, the secondary vessel access port was plugged, the process vessel shielded, and the reactants then subjected to dynamic vacuum treatment at ambient temperature for about 0.5-hour. Subsequently about 250-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for about 24 hours, the reactor-furnace assembly was sealingly connected to the inlet of a quadrupole mass spectrometer. Some of the resultant product gas was metered into the mass spectrometer and analyzed. The nitrogen isotopic result thus obtained was 0.5 atom % ¹⁵N. Natural isotopic abundance for nitrogen is about 0.4 atom % ¹⁵N.

### Example 4

### Lyophilized Algal Cells-¹⁵N

Lyophilized algal cell-¹⁵N specimen (0.08-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1.5-gram) was loaded into quartz boat 15 within the sorption region of the vessel. Next, the secondary vessel access port was plugged, the process vessel shielded, and the reactants then subjected to dynamic VHT at 250° C. for at least ten hours. Subsequently about 250-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for about 24 hours, the reactor-furnace assembly was sealingly connected to the inlet of a quadrupole mass spectrometer. Some of the resultant product gas was metered into the mass spectrometer and analyzed. The average nitrogen isotopic result thus obtained was greater than 98.8 atom % ¹⁵N.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. An apparatus for isolating a nitrogen fraction representative of the nitrogen contained in a specimen of a nitrogenous organic composition, said fraction being isolated in the form of a dinitrogen gas that may be introduced into a mass spectrometer for determining the proportion of the nitrogen isotope content of said composition that is constituted by ¹⁵N, the apparatus comprising:
a tubular process vessel having a primary gas port for influx of a primary oxidant gas and/or efflux of nitrogen gas generated by combustion within the vessel;
a first station within said vessel for receiving a condensed phase specimen of a nitrogenous organic composition, said first station being spaced from said outlet with respect to the longitudinal axis of said vessel;
a second station within said vessel, said second station being spaced from both said first station and said outlet with respect to the longitudinal axis of said vessel;
said second station being adapted to receive a sorbent, said sorbent being effective for sorption of a component of a gas phase in contact with the sorbent, said sorbent being effective for sorption of a gas component selected from the group consisting of water, carbon dioxide and combinations thereof; and
a furnace for heating said organic composition in the presence of a primary oxidant to effect combustion of said specimen and generation of a combustion product gas comprising N₂, CO₂ and water.

69. Apparatus as set forth in claim 68 wherein said first station comprises a holder for said specimen and said second station comprises a holder for said sorbent.

70. (canceled)

71. (canceled)

72. Apparatus as set forth in claim 68 wherein each of said stations is within a single compartment within said tubular process vessel.

73. Apparatus as set forth in claim 72 comprising closures effective for rendering said single compartment of said tubular vessel both isolated and gastight.

74. Apparatus as set forth in claim 72 further comprising a gas manifold that can be placed in a gas flow communication with said tubular process vessel via a valve that can be closed to isolate said process vessel from said manifold.

75. Apparatus as set forth in claim 74 wherein said valve comprises an adjustable metering valve.

76. Apparatus as set forth in claim 74 wherein said valve comprises a block valve.

77. Apparatus as set forth in claim 74 wherein said gas manifold comprises an access port which may be connected to the primary gas port of said tubular process vessel via said valve when said valve is open, said manifold further comprising a plurality of other ports, each of said plurality of other ports being adapted, optionally and alternatively, to be either plugged or connected to a pressure gauge, a transducer, a controller device, a source of molecular oxygen, a source of dynamic vacuum, or the gas inlet port of a mass spectrometer, gas chromatograph or other analytical instrument for gas analysis.

78. Apparatus as set forth in claim 68 wherein said tubular process vessel comprises a single gas flow port for inflow of a primary oxidant gas and outflow of said nitrogen gas fraction gas therefrom.

79. Apparatus as set forth in claim 78 wherein said apparatus comprises a secondary process vessel access port that may be either plugged, or connected to a pressure transducer, or connected to a said containment module, or connected to other useful devices.

80. Apparatus as set forth in claim D8 wherein said apparatus comprises a secondary process vessel access port that may be sealingly connected to and in fluid communication with a specimen containment module that may contain a condensed-phase specimen of nitrogenous composition.

81. Apparatus as set forth in claim 79 wherein said combustion station and said sorption station are between said primary gas port and said secondary port with respect to the longitudinal axis of said tubular process vessel.

82. Apparatus as set forth in claim 81 wherein said tubular process vessel further comprises a process vessel access port for connection to a vacuum pump, or gas ejector, or gas manifold, or gas analyzer.

83. (canceled)

84. Apparatus as set forth in claim 68 further comprising a third station spaced from both said first station and said second station with respect to the longitudinal axis of said tubular process vessel, and capable of containing a chemical reductant at said third station.

85. (canceled)

86. (canceled)

87. (canceled)

88. Apparatus as set forth in claim 84 wherein said third station is positioned within said process vessel at a location where a temperature effective for NOₓ reduction may prevail during combustion.

89. Apparatus as set forth in claim 79 wherein said tubular vessel comprises a tubular combustion region segment surrounding said combustion station, and a tubular transition glass segment between said combustion region segment and said primary gas port, said transition glass segment being fused at it its inward end to said combustion region segment and in a gas flow communication at its outward end with said primary gas port, said combustion region segment being constituted of a glass capable of withstanding combustion temperatures in excess of about 500° C., said primary gas port segment comprising borosilicate glass, and the composition of the glass at the inward end of said transition segment that is fused to said combustion region segment being such that any difference between the coefficient of thermal expansion of said combustion region segment and the coefficient of thermal expansion of said transition segment at the inward end thereof is small enough so that the joint between said combustion region segment and each said transition segment remains substantially stable when said combustion region is repetitively cycled between about ambient temperature and a temperature of about 500° C.

90. (canceled)

91. Apparatus as set forth in claim 89 wherein the glass of which said combustion segment is constituted is capable of withstanding a temperature of about 750° C., and the joint between said combustion segment and said transition segment remains stable when said combustion region is repetitively cycled between about ambient temperature and about 750° C.

92. Apparatus as set forth in claim 89 further comprising another tubular transition glass segment between said combustion segment and said secondary access port, said another transition glass segment being fused at its inward end to said combustion region segment and in gas flow communication at its outward end with said secondary access port, said secondary access port comprising borosilicate glass, and the composition of the glass at the inward end of the another transition segment that is fused to said combustion region segment being such that any difference between the coefficient of thermal expansion of the combustion region segment and the another transition segment at the inward end thereof is small enough so that the joint between said combustion region segment and said another transition segment remains substantially stable when said combustion region is repetitively cycled between about ambient temperature and a temperature of about 500° C.

93. (canceled)

94. Apparatus as set forth in claim 92 wherein the glass of which said combustion segment is constituted is capable of withstanding a temperature of about 750° C., and the joint between said combustion segment and said another transition segment remains stable when said combustion region is repetitively cycled between about ambient temperature and about 750° C.

95. Apparatus as set forth in claim 92 said sorption station is in said another transition segment.

96. (canceled)

97. Apparatus as set forth in claim 89 wherein said tubular process vessel may be reused for greater than about 50 combustion/sorption cycles.

98. (canceled)

99. (canceled)

100. (canceled)

101. (canceled)

102. Apparatus as set forth in claim 89 wherein said primary gas port segment is adapted for a gas flow connection to a source of molecular oxygen, a gas analyzer, a vacuum source or a gas manifold.

103. Apparatus as set forth in claim 89 wherein said primary gas port comprises a flange, threaded socket or threaded nipple at its outer end for hermetically sealed connection to a mating flange, nipple or bushing on a conduit in gas flow communication with said source of molecular oxygen, said gas analyzer, said vacuum source or said gas manifold that is threadably connected to the outer end of said primary gas port segment.

104. Apparatus as set forth in claim 68 wherein said furnace may be comprised of one heater with capability to establish and maintain a temperature in a said combustion region from about ambient temperature to about 800° C.

105. Apparatus as set forth in claim 68 wherein said tubular process vessel and said furnace can comprise a combined assembly capable of wheel mobility.

106. (canceled)

107. (canceled)
